(19) United States
(12) Patent Application Publication
(10) Pub. No.: US 2005/0074323 A1
(43) Pub. Date: Apr. 7, 2005

(54) Sail wing type windmill and operation method of same

(76) Inventor: Chuy-Nan Chio, Taipei (TW)

Correspondence Address: HDSL, 4331 STEVENS BATTLE LANE, FAIRFAX, VA, 22033, US

(21) Appl. No.: 10/958,253

(22) Filed: Oct. 6, 2004

(30) Foreign Application Priority Data
Oct. 6, 2003 (TW) 092127619

(51) Int. Cl. F03D 7/00

(52) U.S. Cl. 415/4.2

(57) ABSTRACT

A wing type windmill is provided with a rudder able to constantly facing to the wind direction controlled by turn table having a twin vaned tail wing and a concave upwardly curved lead rail. The vertically shafted windmill has several sail type wing blades each of them can develop or shrink its surface to face or offset the wind direction following the up and down motion of the end roller of the connecting rod along the lead rail. The produced rotating torque by individual wing blade is imparted to a centrifugal fly wheel hub from time to time and this non-uniform torque and unstable rotating speed of the windmill is unified and governed stably by the fly wheel effect of a plurality of fly wheels filled with a weighty substance.

### BACKGROUND OF THE INVENTION

1. Field of the Invention

The present invention relates to a sail wing type windmill and operation method of same, and more particularly, to a sail wing type windmill to convert the wind power into the mechanical power, and its operation method.

2. Description of the Prior Art

It is well known that the windmill has been utilized to convert the wind power into electric power for thousands of years, and conversion of wind power to electricity has been paid great attention by the whole word due to serious energy shortage which is possible to come before long.

In a typical windmill power station, a horizontal shaft windmill composed of three or four vaned wing with fly wheels is coupled to the generator shaft to drive the generator with the windmill. The rotating power of the windmill comes from upwards and downwards wind flow attacking the wing blades of the windmill, whereas the flywheel is for storing the kinetic energy and governing the rotational speed of the windmill. However, the conventional technique used to convert the wind power into the electric power described above has several shortcomings, namely:

(1) The efficiency of energy conversion is so low as only 20˜30%, as a matter of fact, the wind direction changes from time to time, this might lower the efficiency even down to 70% of its original value.

(2) Traditionally, the windmill is supported by a very high tower which requires a high investment for establishment and routine maintenance.

(3) A windage force produced during cutting wind by wing blades and flywheels might become overturning torque to destroy the structure of the windmill.

(4) Time lag in guiding the direction of wing blades to accept the wind power effectively results in loosing the effective area of the wing blades.

For these defects noticeable on the prior arts, an improvement is seriously required. The inventor has dedicated great efforts for years to studying and improving these defects and come up with a novel sail wing type windmill and its operation method as provided in this invention to eliminate the defects inherent to the prior arts.

### SUMMARY OF THE INVENTION

Accordingly, the present invention is to provide a power generating windmill to convert the wind power into the electric power.

The present invention is to provide a sail wing type windmill which can work in all direction without the need of tracing the wind direction from time to time, and the windmill can be fabricated and assembled with reduced cost while it can be operated securely.

According to the present invention, a vertical shaft is provided for the windmill instead of the conventional horizontal shaft so as to reduce the engineering cost. A sail type wing blade is adopted to replace the propeller type wing blade thereby eliminating the windage loss arising from cutting the wind strata to improve energy conversion efficiency as high as possible.

A rudder is designed to turn freely about the windmill shaft by a turn table which has a twin vaned tail wing at its rear end which can automatically turn the rudder to face against the wind direction by the turn table with a concave upwardly curved lead rail. The wing blade and the lead rail is connected with a connecting rod which is movable on the lead rail with an end roller and jointed with the wing blade at its front portion. When the end roller of the connecting rod rolls upwards, the surface of the wing blade is gradually laid parallel to the wind direction and there will be no wind pressure exerted upon it. On the other hand, as the end roller of the connecting rod rolls downwards, the wind pressure exerted on the wing blade gradually increases. When the wing blade is fully developed to lead the wind direction normal to its surface, the exerted wind pressure is maximum to operate the windmill most effectively.

Several fly wheels are provided radially extended from a fly wheel hub. Each fly wheel is configurated into a stream saucer (or spherical) form so as to reduce the wind resistance. Each fly wheel is filled with a weighty substance to improve its fly wheel effect. By so, these fly wheels can adjust the non-uniform rotating torque of the windmill arising from the unstably varying wind force by their fly wheel effect thereby the windmill is able to rotate with a constant speed in spite of the situation the wind pressure exerted on its wing blades is varying from time to time.

### BRIEF DESCRIPTION OF THE DRAWINGS

The drawing disclose an illustrative embodiment of the present invention which serves to exemplify the various advantages and objects hereof, and are as follows:

FIG. 1 is a perspective view of the present invention;

FIG. 2 is a schematic view showing the connection of the wing blade and the fly wheel according to the present invention;

FIG. 3 is a schematic view illustrating how the lead rail of the wing blades is operated according to the present invention; and

FIG. 4 is a schematic view of the rotating wing blades looked downwards.

### DETAILED DESCRIPTION OF THE PREFERRED EMBODIMENT

Hereinbelow, the preferred embodiment of the present invention will be described in detail in conjunction with the accompanied drawings:

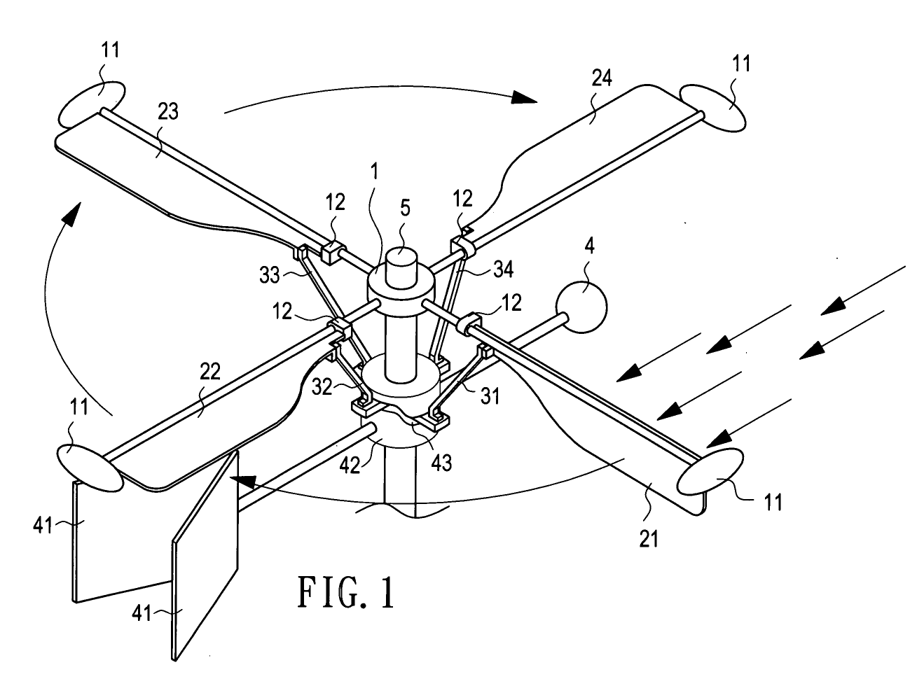

Referring to FIG. 1, in the perspective view of the present invention, a shaft 5 of the windmill is vertically erected to be conjoined with the rotating shaft of a generator. A fly wheel hub 1 is coupled to the shaft 1 and several centrifugal fly wheels 11 are radially extended from the hub 1 each with a supporting brace so that the fly wheels 11 are disposed circularly. Each fly wheel 11 is configurated into a stream saucer (or spherical) form so as to reduce the windage resistance. Each fly wheel 11 is filled with a weighty substance to improve its fly wheel effect.

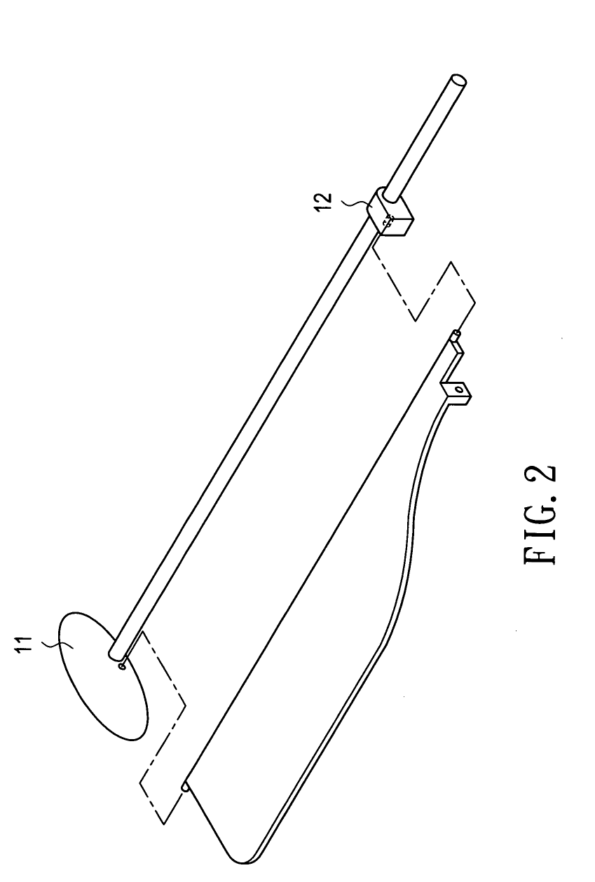

Referring to FIG. 2 together with FIG. 1, each supporting brace of the fly wheel 11 is provided with a jaw 12 proximate to the hub 1 to hook each of fan blades 21, 22, 23, 24 onto a recess hole formed onto the brace so that the fan blades 21, 22, 23, 24 are rotatable along with the fly wheels 11.

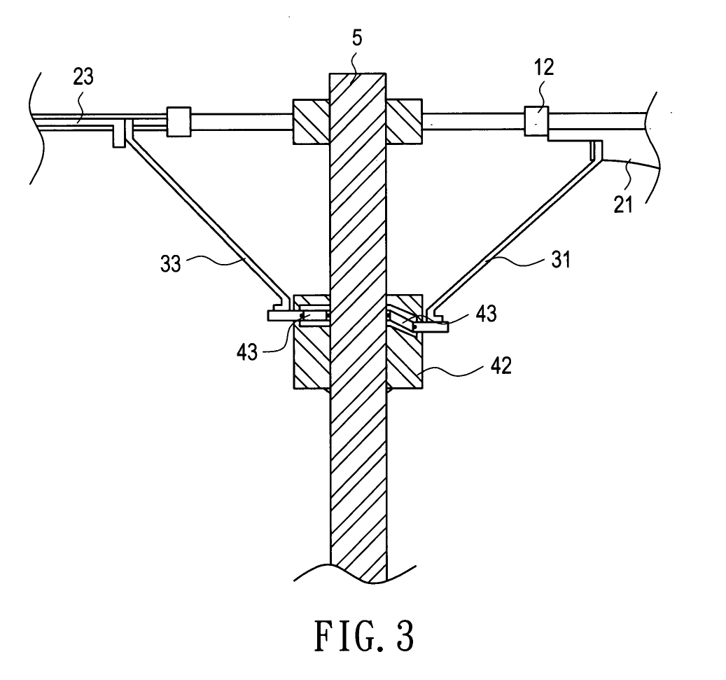

Referring to FIG. 3, a rudder 4 is designed to turn freely about the shaft 5 by a turn table 42 which has a twin vaned tail wing 41 at its rear end to divide the wind stream flowing in the two directions along each of the two symmetrically arranged vanes with respect to the rudder lever. With this structure, the rudder 4 can be constantly turned to face against the wind direction by the turn table 42 so as to trace the wind direction automatically. The turn table 42 is provided with a concave upwardly curved lead rail 43 offset of the wind direction. Each of the wing blades 21, 22, 23, 24 is respectively connected to the lead rail 43 with each of the connecting rods 31, 32, 33, 34 which is movable on the lead rail 43 with an end roller, while its front portion is jointed to the wing blade 21. Returning to FIG. 1, all the wing blades, 23, 22, 23, 24 have at least on in operation and others with their blade surfaces in parallel to the wind direction so as to evade the wind pressure. For example, as the end roller of the connecting rod 31 gradually rolls down along the lead rail 32, the wing blade 21 develops its blade surface to accept the wind flow. When the wing blade 21 is completely developed, the wind pressure is exerted normal to its blade surface such that the windmill is ready to work with maximum efficiency. At this moment, the velocity of the air molecules flowing along the surface of the wing blade 21 is approximately equal to the wind velocity. The velocity of the air molecules gradually slows down as the air molecules approaches the rear surface of the wing blade 21 so that there appears a wind pressure difference between the two surfaces of the wing blade 21, and this difference is further enlarged by the air viscosity to the rear surface of the wing blade 21 arising from the random air current passing therealong. A clockwise rotating torque (see FIG. 1) is then imparted to the centrifugal fly wheel hub 1.

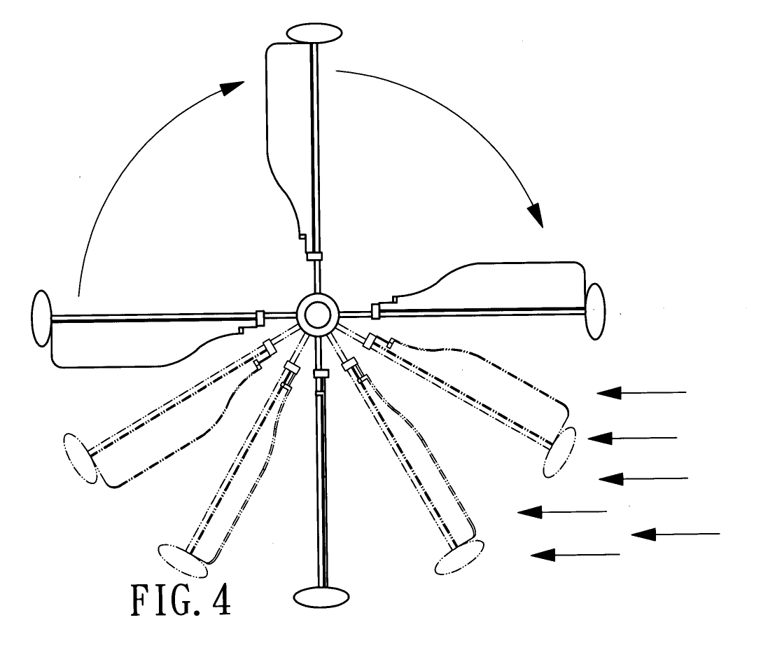

Referring to FIG. 4 together with FIG. 1, as the wing blade 21 gradually turns towards the position of the preceeding wing blade 22, the end roller of the connecting rod 31 rolls up along the lead rail 43 to shrink the surface of the wing blade 21 in wind direction thereby evading ineffective wind pressure. As soon as the wing blade 21 has reached the position where the wing blade 22 occupied, the surface of the wing blade 21 is completely in parallel to the wind direction and the wing blade 24 will be at the position of the wing blade 21 to accept the wind flow. Such an operation mode is similarly applicable to rest of the wing blades 22, 23, 24 thereby successively imparting the fly wheel hub 1 a continuously clockwise rotating torque as long as the wind continues to flow. Incidentally, the surface of the wing blade can be granulated to increase the friction with wind stream.

In case of the unsteady wind pressure, the rotational energy input to the centrifugal fly wheel hub 1 will vary from time to time which causes the windmill does not able to operate stably. For a remedy, the centrifugal fly wheel 11 filled with a weighty substance contributes to serving the fly wheel effect with its improved rotational inertia by adjusting the non-uniform rotating torque of the windmill arising from the unstably varying wind pressure and governing the windmill to operate under constant rotational speed as well,

It should be understood that the present invention is a high level technical creation and by no means, Simply utilizes conventional technology or knowledge known prior to the application for patent, or can easily be made by persons skilled in the arts. Prior to the application for patent, the invention has neither been published or put to practical use, nor displayed in an exhibition.

Many changes and modifications in the above described embodiment of the invention can, of course be carried out without departing from the scope thereof. Accordingly, to promote the progress in science and the useful arts, the invention is disclosed and is intended to be limited only by the scope of the appended claims.

1. A sail wing type windmill comprising:
a vertical shaft;
a fly wheel hub coupled to the vertical shaft, having a plurality of centrifugal fly wheels circularly disposed to a plurality of supporting braces radially extended from hub respectively;
a plurality of wing blades rotatably connected to the supporting braces respectively;
a turn table turnably with respect to the shaft, having a lead rail with a concave upwardly curved figure offsetting wind direction formed on the surface;
a connecting rod movable on a lead rail with an end roller, and its front portion being jointed to said wing blade; and
a rudder having a twin vaned tail wing at a rear end so as to keep the rudder constantly facing to wind direction.

2. The windmill of claim 1, wherein the surface of the wing blade is granulated to increase the friction with wind stream.

3. The windmill of claim 1, wherein the fly wheel is configurated into a stream saucer or spherical form.

4. A method of operating a sail wing type windmill comprising the steps:
forming a lead rail of a turn table into a concave upwards curved figure to offset the wind direction so as to keep a rudder constantly facing to the wind direction;
rolling an end roller of a connecting rod down along the lead rail to develop a wing blade to accept a normal wind pressure thus creating maximum wind pressure difference between front and rear surfaces of the wing blade, and imparting a maximum rotating torque to a centrifugal fly wheel hub;
moving the wing blade towards the position of the preceeding wing blade by rolling up the end roller of the connecting rod along the lead rail to shrink the surface of the wing blade in wind direction and to stop imparting the rotating torque to the centrifugal fly wheel hub; and
repeating the above stated operation steps for rest of wing blades one by one thereby successively imparting the fly wheel hub a rotating torque as long as the wind continues to flow, while the rotating torque and speed are unified and governed stably by the fly wheels filled with a weighty substance.
